(19) United States
(12) Patent Application Publication
(10) Pub. No.: US 2024/0055657 A1
(43) Pub. Date: Feb. 15, 2024

(54) AMPHIPHILIC COMPLEXING AGENTS FOR IMPROVED MEMBRANE COMPATIBILITY AND STABILITY OF REDOX SPECIES

(71) Applicant: Wisconsin Alumni Research Foundation, Madison, WI (US)

(72) Inventors: Patrick Sullivan, Madison, WI (US); Dawei Feng, Madison, WI (US); Xiuliang Lyu, Madison, WI (US); Gyohun Choi, Madison, WI (US)

(21) Appl. No.: 18/446,192

(22) Filed: Aug. 8, 2023

Related U.S. Application Data
(60) Provisional application No. 63/396,759, filed on Aug. 10, 2022.

(51) Int. Cl. H01M 10/0566; H01M 6/04

(52) U.S. Cl. CPC H01M 10/0566; H01M 6/045

(57) ABSTRACT

Amphiphilic complexing agents for use in electrolyte solutions are provided. The complexing agents include at least one soft ionic group covalently bonded to at least one hard ionic group or polyether chain. The soft ionic group couples with soft, oppositely charged ionic redox species in an electrolyte solution, and the hard ionic groups or polyethylene chains render the complexes formed by the complexing agents and ionic redox species soluble in the electrolyte solution. The size of the complex formed by the coupling of the amphiphilic complexing agent to the soft ionic redox species is substantially larger than the size of the soft ionic redox species alone and, as a result, electrochemical cells that include the amphiphilic complexing agents in an electrolyte solution have less membrane crossover than analogous electrochemical cells that do not include the amphiphilic complexing agents.

### CROSS-REFERENCE TO RELATED APPLICATIONS

The present application claims priority to U.S. provisional patent application No. 63/396,759 that was filed Aug. 10, 2022, the entire contents of which are incorporated herein by reference.

### BACKGROUND

One approach to grid energy storage is the use of redox flow batteries (RFBs), which have decoupled energy and power scaling because the capacity can be enlarged by simply expanding the size of the storage tanks. This decoupling of capacity and power allows for the simplified design of long-storage-duration devices by increasing the amount of active energy storage materials without concurrently needing to increase the electrode sizes. Despite this practical advantage, RFBs have only been commercially implemented in a handful of experimental grid applications. This is partially due to unwanted electrolyte crossover through the ion-permeable membrane separating the anolyte and catholyte solutions. This problem arises from the relatively large ion conductive channels in state-of-the-art ion exchange membranes and the relatively small size differences between the electrolyte species and the charge-balancing ions in the electrolyte solutions. This unwanted crossover leads to electrochemical cells having a fast capacity decay, low energy efficiencies, and operational heat generation.

One approach that has been used to address the problem of electrolyte crossover is the use of charged complexing agents in the electrolyte solution (e.g., in a bromide flow battery). These complexing agents entrap charged redox species based on system thermodynamic equilibrium. Due to its larger size, the complex formed by the complexing agent and the charged redox species (e.g., polybromide) is less susceptible to membrane crossover. However, significant membrane crossover of the complexing agent/electrolyte complex is still a problem and phase separation of the complexing agent/electrolyte complex frequently occurs. As a result, electrochemical cells and, particularly, RFBs that include known complexing agents still suffer from fast capacity decay and low energy efficiencies, in addition to kinetic and flow issues. These challenges have severely limited the commercial success of RFBs.

### SUMMARY

Amphiphilic complexing agents for use in electrolyte solutions and electrochemical cells that utilize the electrolyte solutions as catholyte solutions or anolyte solutions are provided.

One embodiment of an electrolyte solution includes: a solvent; a soft ionic redox species, which may be cationic or anionic (the phrase “cationic or anionic” is abbreviated herein as “cationic/anionic” and the phrase “anionic or cationic” is abbreviated herein as “anionic/cationic”) dissolved in the solvent; charge-balancing counter ions dissolved in the solvent; and an amphiphilic complexing agent dissolved in the solvent. The amphiphilic complexing agent has a soft ionic group covalently bonded to a hard ionic group, a polyethylene glycol chain, or a combination thereof. The soft ionic group and the soft ionic redox species are oppositely charged and the soft ionic group and hard ionic groups of the amphiphilic complexing agent may have opposite charges (e.g., cationic and anionic or anionic and cationic) or may have the same charge type (e.g., both anionic or both cationic).

One embodiment of an electrochemical device includes: an anode in an anolyte solution; a cathode in a catholyte solution; and an ion-permeable membrane separating the anolyte solution from the catholyte solution. In the electrochemical device, either or both of the anolyte solution and the catholyte solution comprises an electrolyte solution as described herein.

Other principal features and advantages of the invention will become apparent to those skilled in the art upon review of the following drawings, the detailed description, and the appended claims.

### BRIEF DESCRIPTION OF THE DRAWINGS

Illustrative embodiments of the invention will hereafter be described with reference to the accompanying drawings, wherein like numerals denote like elements.

FIG. 1A is a schematic illustration of the complexing of an amphiphilic complexing agent with a soft anionic redox species and its charge-balancing hard cation.

FIG. 1B is a schematic illustration of the complexing of an amphiphilic complexing agent with a hard anionic redox species and its charge-balancing soft cation.

FIG. 2 shows the structures of various soft quaternary ammonium, protonated secondary and tertiary ammonium, heteroaromatic, heterocyclic, phosphonium, and sulfonium cations.

FIGS. 3A-3B show generic structures for various amphiphilic complexing agents that include a soft quaternary ammonium or soft nitrogen-containing heteroaromatic group. “NG” in the figure represents an anionic group.

FIGS. 4A-4F show the structures of specific examples of amphiphilic complexing agents that include a soft quaternary ammonium or soft nitrogen-containing heteroaromatic group. Viologen (top structure in FIG. 4C) is an example of a redox-active complexing agent.

FIG. 5 shows the structures of various soft, redox-active metal-ligand coordination complexes.

FIG. 6 shows the structures of specific examples of redox-active amphiphilic complexing agents that include a soft metal-ligand coordination complex as a soft cationic group.

FIG. 7 shows the structures of specific examples of redox-active amphiphilic complexing agents that include a redox active soft cationic group.

FIG. 8 shows the structures of some polymeric amphiphilic complexing agents.

FIG. 9A shows a reaction scheme for the synthesis of amphiphilic complexing agents.

FIG. 9B shows alternative reaction schemes for the synthesis of amphiphilic complexing agents.

FIG. 10 shows another reaction scheme for the synthesis of amphiphilic complexing agents.

FIGS. 11A-11H show various reactants that can be used to synthesize amphiphilic complexing agents.

FIG. 12 shows the complexing of an anionic catholyte and an amphiphilic complexing agent in a catholyte solution.

FIG. 13 is a schematic diagram of an aqueous organic redox flow battery.

FIGS. 14A and 14B show the structures of 13 amphiphilic complexing agents that can be used with soft cationic redox species that were synthesized in accordance with the procedures described in the Example, along with their experimentally measured permeabilities.

FIGS. 15A and 15B demonstrate the performance of a redox flow battery using an amphiphilic complexing reagent, as described in the Example.

### DETAILED DESCRIPTION

Amphiphilic complexing agents for use in electrolyte solutions are provided. Also provided are electrolyte solutions that contain the amphiphilic complexing agents and electrochemical cells that utilize the electrolyte solutions as catholyte solutions or anolyte solutions.

The complexing agents are molecules that include at least one soft ionic group covalently bonded, via a covalent linkage, to at least one hard ionic group and/or polyether chain via a covalent linkage. The soft ionic groups of the complexing agents couple with soft ionic redox species in an electrolyte solution due to thermodynamic equilibria in solution, while the hard ionic groups and/or polyethylene chains, which are strongly hydrophilic, couple with hard counter ions in the solution to prevent the complexes from phase separating out of aqueous solutions.

The size of the complex formed by the coupling of the amphiphilic complexing agent to the soft redox species is substantially larger than the size of the redox species alone and, as a result, electrochemical cells that include the amphiphilic complexing agents in an electrolyte solution have much less membrane crossover than analogous electrochemical cells that do not include the amphiphilic complexing agents. As a result, electrochemical cells that include the amphiphilic complexing agents in an electrolyte solution are characterized by improved cycling stabilities, higher coulombic efficiencies, and higher utilized capacities.

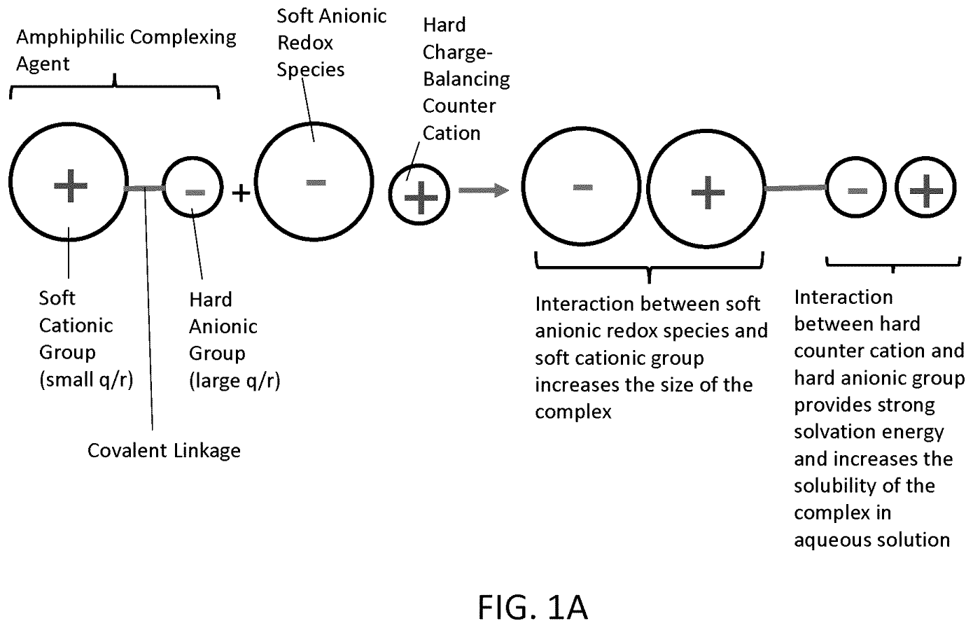

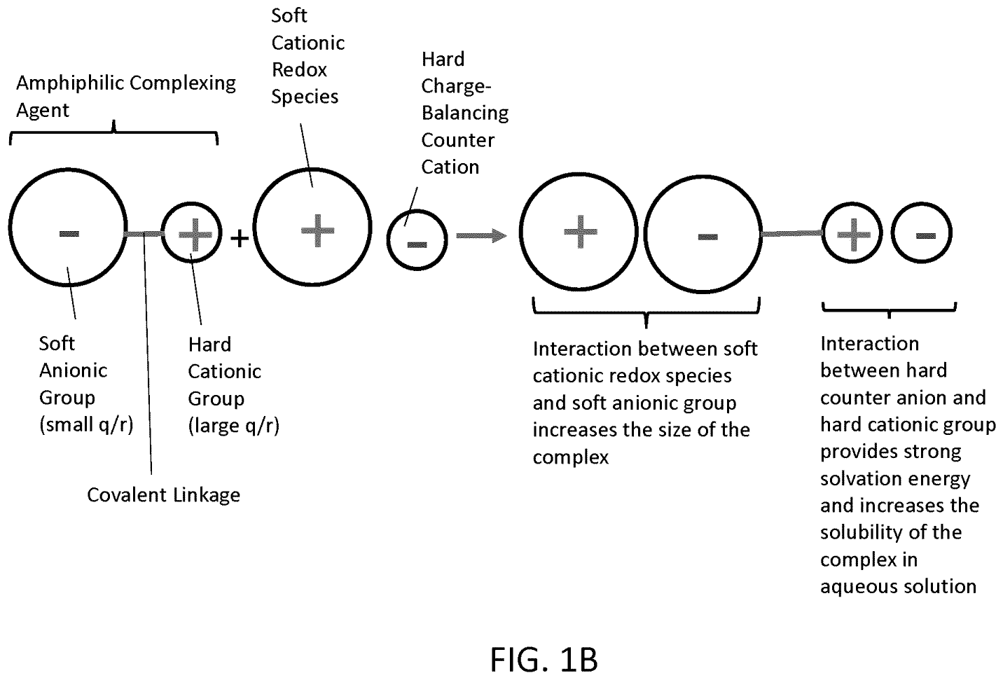

The complexing of an amphiphilic complexing agent, a soft anionic redox species, and its hard counter ion to form a large, water-soluble complex is shown schematically in FIG. 1A. The complexing of an amphiphilic complexing agent, a soft cationic redox species, and its hard counter ion to form a large, water-soluble complex is shown schematically in FIG. 1B. It should be noted that, although the soft and hard ionic groups of the complexing agent have opposite charges in FIGS. 1A and 1B, it is also possible to use amphiphilic complexing agents in which the soft and hard ionic groups have the same charge, provided that the soft redox species is also of the same charge type (cationic or anionic).

Generally, “soft” ionic groups and ions have a smaller charge to size ratio than “hard” ionic groups and ions. While the “soft” or “hard” nature of an ionic group does not lend itself to quantification, soft and hard ionic groups can be identified based on how these groups interact with ions in an aqueous solution. For the purposes of this disclosure, a hard ionic (anionic or cationic) group on a complexing agent is characterized in that said ionic group prefers to interact with (i.e., is more strongly attracted to) the counter ion (for example a charge-balancing cation or anion) of the ionic redox species, rather than with the soft ionic group of the complexing agent. The ionic redox species and the other ionic group of the complexing agent are, therefore, categorized as “soft” because they are left to coordinate with one another. By way of illustration, in the case of an amphiphilic complexing agent having a soft cationic group and a hard anionic group, as long as the interaction between the charge-balancing counter cations of an anionic redox species and the anionic group of a complexing agent is stronger than the interaction between the cationic group of the complexing agent and the anionic group of the complexing agent, the cationic group of the complexing agent can be considered “soft”. Due to their relatively large sizes and relatively low charge densities, the organic cationic groups of the complexing agents will be soft relative to any metal cation and NH₄⁺. Due to their relatively small size and relatively high charge densities, counter anions, such as Cl⁻, Br⁻, CO₃²⁻, SO₄²⁻, OH⁻, NO₃, CH₃SO₃, CF₃SO₃, and the like, are characterized as hard anions.

The hard anionic groups of the amphiphilic complexing agents include anionic sulfate, phosphate, and carboxylate groups. As described in more detail herein, these hard anionic groups may be attached to the soft ionic groups via organic linker chains, such that the soft ionic groups are functionalized with sulfonate groups, phosphonate groups, and carboxylate groups. These sulfonate groups, phosphonate groups, and carboxylate groups may be generically represented as R—SO₃⁻, R—PO₃²⁻, and R—COO⁻, respectively, wherein the R comprises an alkyl group covalently linking the —SO₃⁻, —PO₃²⁻, and —COO⁻ groups to a soft ionic group of the amphiphilic complexing agent. The alkyl group will typically have from 1 to 6 carbon atoms. However, longer alkyl groups can be used.

The soft cationic groups in some embodiments of the amphiphilic complexing agents include aliphatic quaternary ammonium groups, cycloaliphatic quaternary ammonium groups, and cationic nitrogen-containing heteroaromatic rings, where the term “quaternary ammonium groups” includes protonated quaternary ammonium groups. The soft cationic groups may be monovalent (having one positively charged atom), divalent (having two positively charged atoms), or may have a higher valency (having three or more positively charged atoms). Aliphatic quaternary ammonium groups include alkyl quaternary ammonium groups, such as trimethyl quaternary ammonium groups and triethyl quaternary ammonium groups. Examples of cycloaliphatic quaternary ammonium groups and cationic nitrogen-containing heteroaromatic groups include imidazolium groups, benzimidazolium groups, pyridinium groups, bipryridinium groups, 1,4-diazabicyclo[2.2.2]octane-1,4-diium groups, aziridinium groups, azetidinium groups, pyrrolidinium groups, piperidinium groups, morpholinium groups, piperazinium group, and imidazolidinium groups.

In some embodiments of the amphiphilic complexing agents, the soft cationic group is a phosphonium cation, while in some embodiments of the complexing agents, the soft cationic group is a sulfonium cation.

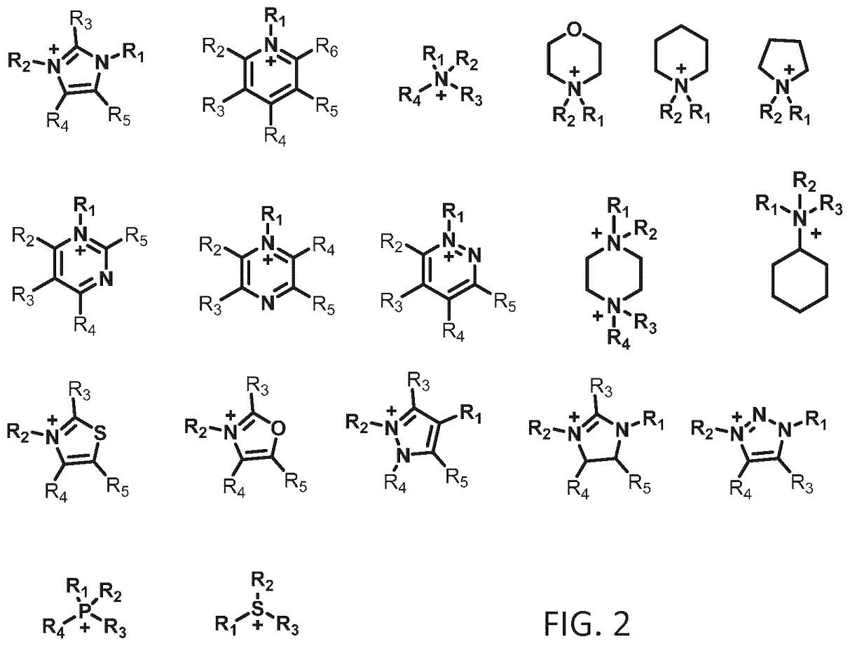

The structures of some soft aliphatic and cycloaliphatic quaternary ammonium cations, cationic nitrogen-containing heteroaromatic cations, phosphonium cations, and sulfonium cations are shown in FIG. 2, wherein R₁-R₅ represent, independently, hydrogen atoms, alkyl groups, alkyl alcohol and/or polyether chains, such a polyethylene glycol chain. The alkyl groups in a soft cationic group may be the same or different. When these soft cations are incorporated into an amphiphilic complexing agent that includes a hard anionic group, at least one R group on a positively charged nitrogen atom, sulfur atom, and/or phosphorus atom will form a covalent linkage to the hard anionic group. The alkyl groups are typically lower alkyl groups, containing from 1 to 6 carbon atoms. However, larger alkyl groups can be used.

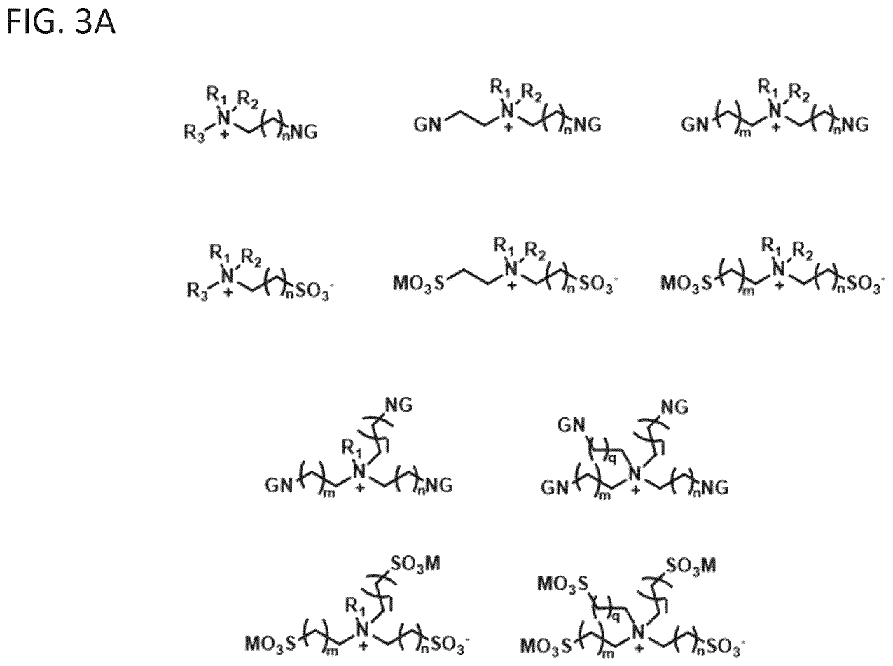

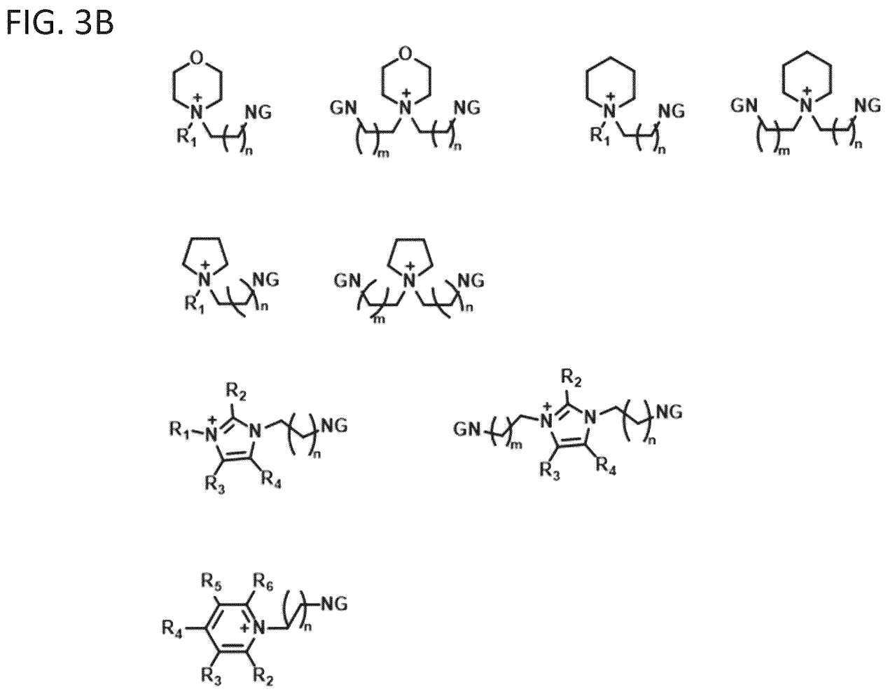

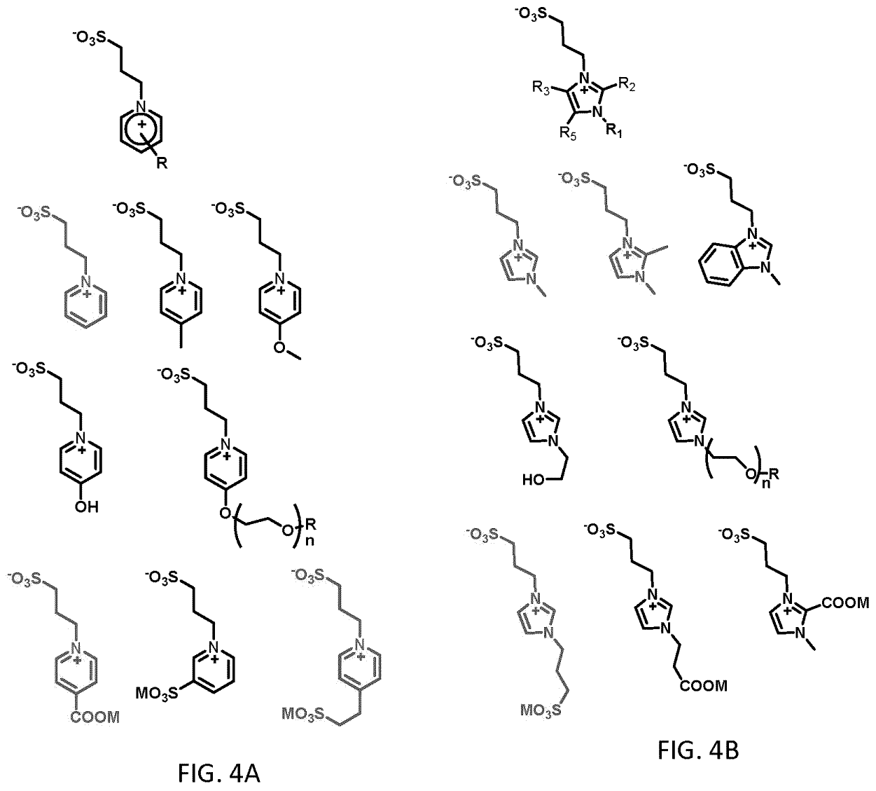

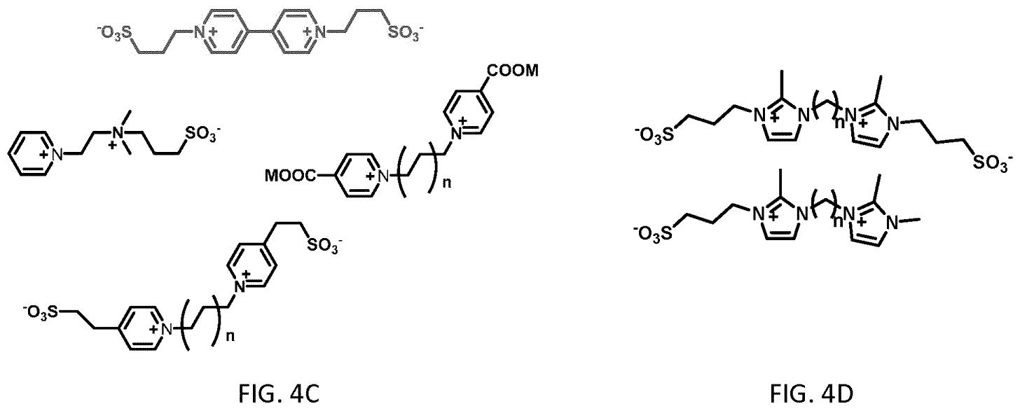

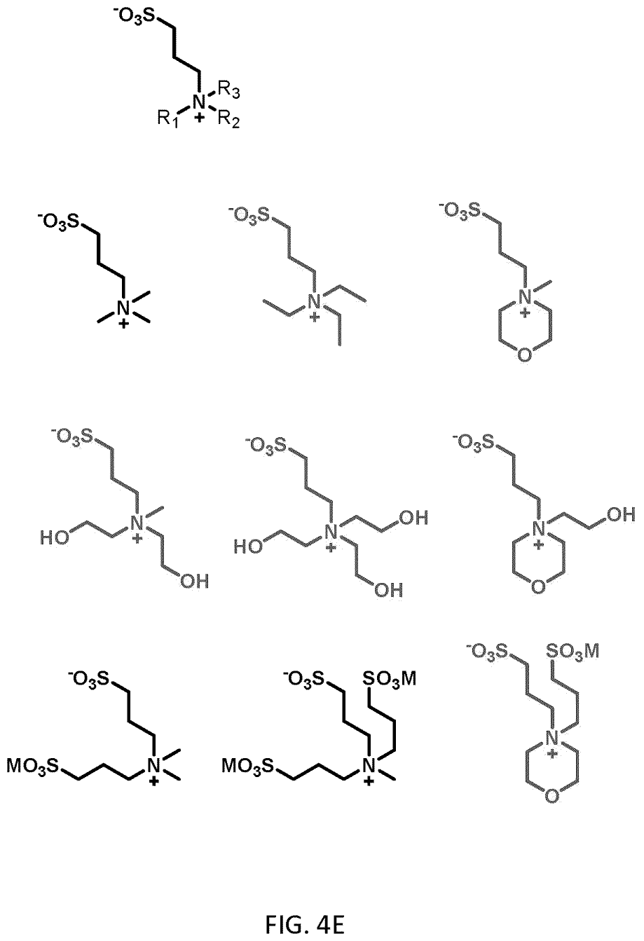

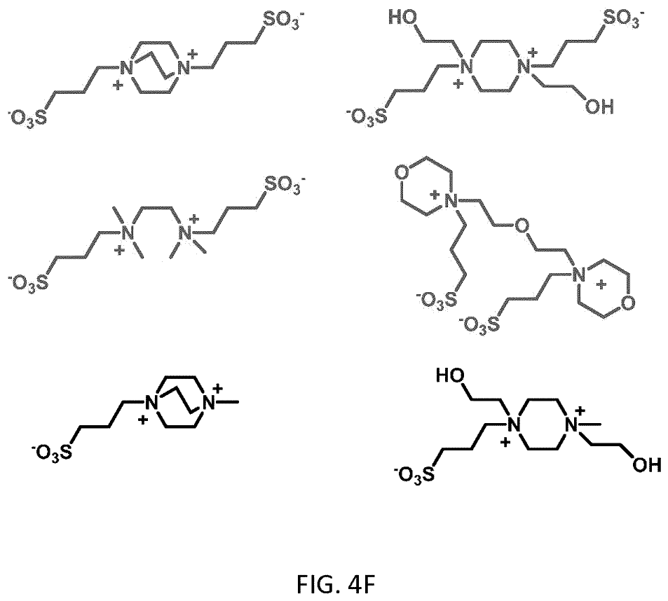

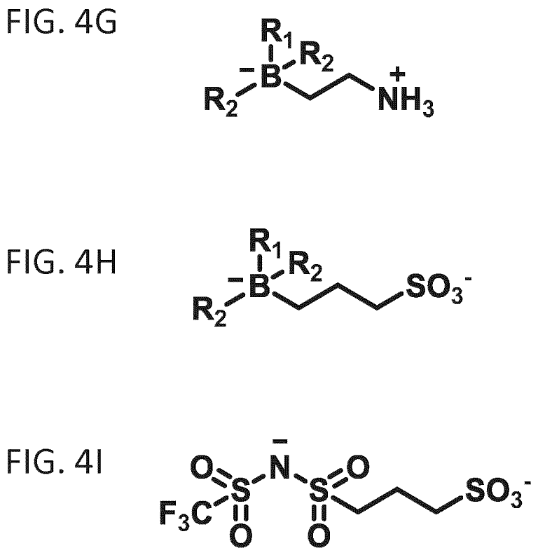

The generic structures of some illustrative amphiphilic complexing agents are shown in FIGS. 3A-3B. In these structures, R₁-R₃ are, independently, hydrogen atoms, alkyl groups, alkyl alcohol groups, or polyether groups, 1, m, n, and q are, independently, integers with a value of 1 or greater, including, but not limited to, integers in the range from 1 to 6, “NG” represents a hard ionic group and M represents a generic charge-balancing cation, such as a metal cation (e.g., a transition metal cation). In some embodiments, NG is a hard anionic group, such as a —SO₃⁻, —PO₃²⁻, or —COO⁻ group. Examples of charge-balancing cations include H⁺, metal cations (e.g., Li⁺, Na⁺, K⁺) or NH₄⁺. Some specific amphiphilic complexing agents having a soft cationic group and a hard anionic group are shown in FIG. 4A-4F. FIGS. 4A-4D show the structures of various amphiphilic complexing agents in which the soft cationic group is a cationic nitrogen-containing heteroaromatic ring having a monovalent (FIGS. 4A and 4B) or divalent (FIGS. 4C and 4D) cationic charge. FIGS. 4E and 4F show the structures of various amphiphilic complexing agents in which the soft cationic group is a monovalent cationic aliphatic or cycloaliphatic quaternary ammonium group (FIG. 4E) or a divalent cationic aliphatic or cycloaliphatic quaternary ammonium group (FIG. 4F). In FIGS. 4A-4F, M represents a charge-balancing counter cation, R₁-R₅ are as previously defined, and R is a hydrogen atom or an alkyl group, such as a C₁-C₆ alkyl group.

Organoborate groups are examples of soft anionic groups. FIG. 4G-4I show examples of amphiphilic complexing agents having a soft anionic group and a hard cationic ionic group (FIG. 4G) a soft anionic group and a hard anionic group (FIG. 4H and FIG. 4I), where R₁ and R₂ in FIGS. 4G and 4H are alkyl groups, alkyl alcohol groups, aryl groups, alkylaryl groups, and/or polyalkylene glycol (e.g., polyethylene glycol) groups. These and other amphiphilic complexing agents comprising a soft anionic group are able to complex with soft cationic redox species, such as cationic-organic complexes. Cationic metal-organic complexes include ferrocenium and metal-organic complexes with cyclopentadienyl or 2,2-bypyrindine ligands, while the hydrophilic hard ionic group provides the complex with a high water solubility.

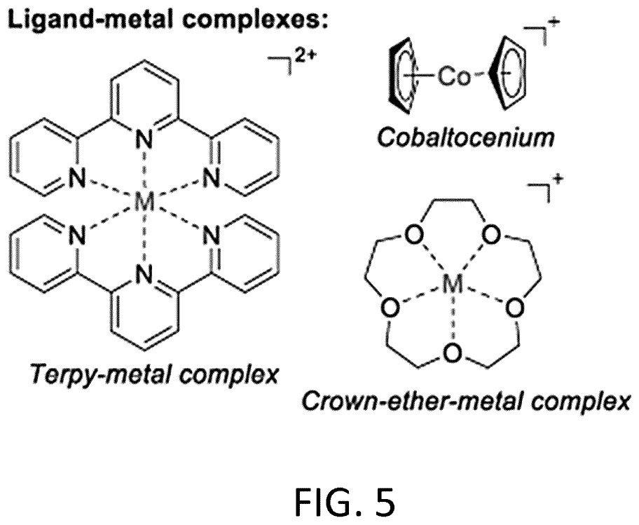

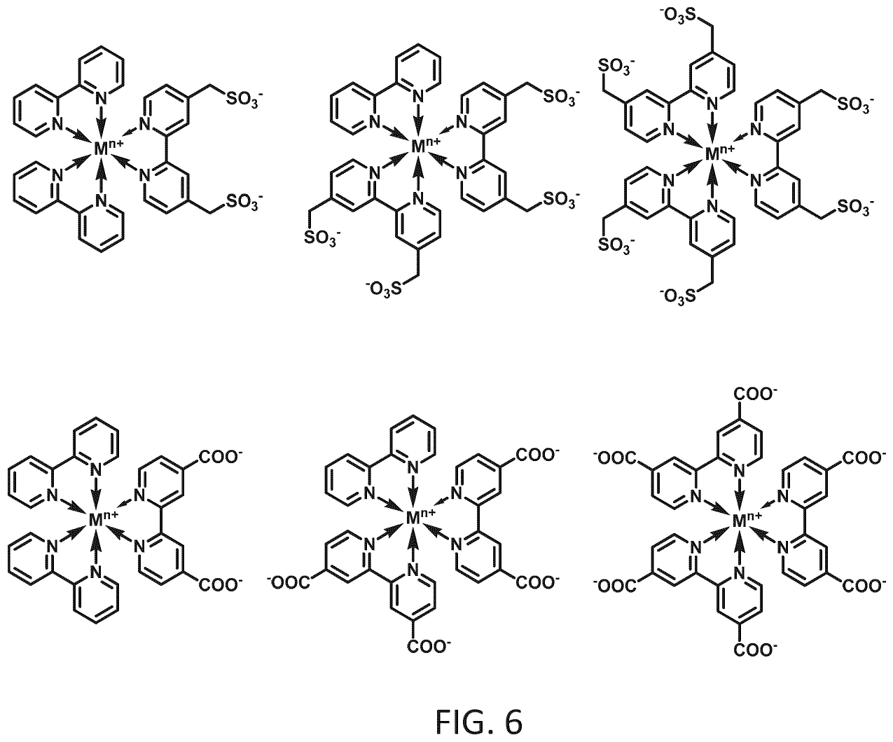

In some embodiments of the amphiphilic complexing agents, the soft cationic group is a coordination complex comprising a central positively charged atom, typically a metal cation, that is surrounded by an array of molecules, which are referred to as ligands. In these redox-active embodiments of the complexing agents, the hard anionic group is covalently bonded to a ligand of the coordination complex. The structures of some coordination complexes that are soft cations are shown in FIG. 5. Some examples of amphiphilic complexing agents in which the soft cationic group is a metal ligand coordination complex are shown in FIG. 6.

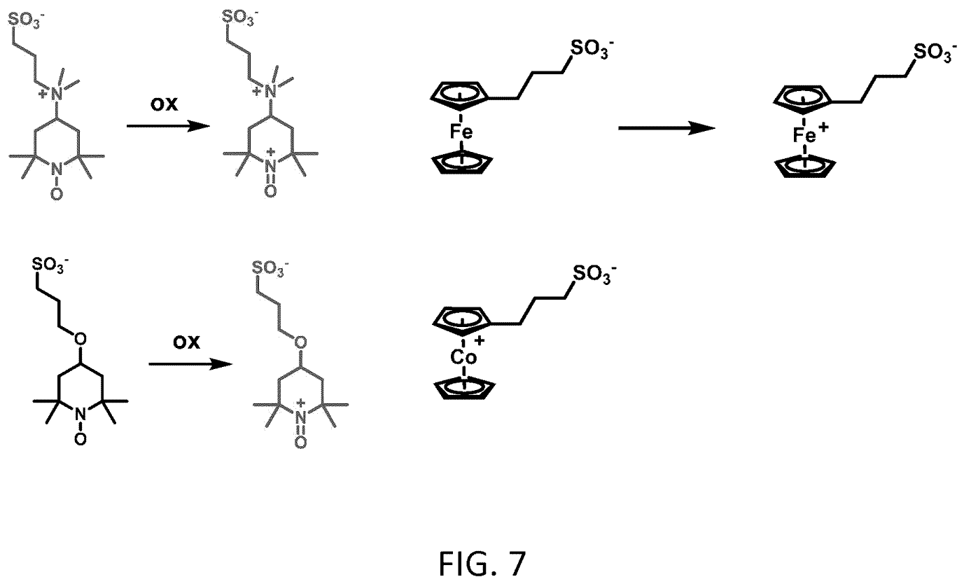

In some embodiments of the amphiphilic complexing agents, the soft cationic group is itself redox active. Examples of redox active groups that have a soft cationic state include nitroxyl radicals, such as substituted or unsubstituted piperidine radicals, pyrrolidine radicals, and imidazolidine radicals, which are converted into soft cationic groups upon oxidation. Specific examples of nitroxyl radical groups that convert to soft cationic groups upon oxidation include 2,2,6,6-tetramethylpiperidine-1-oxyl (TEMPO) groups and 2,2,5,5-tetramethyl-1-pyrrolidinyloxyl (PROXYL) groups. While these amphiphilic complexing agents are themselves redox active, they can be combined with other anionic redox species in an electrolyte solution in order to reduce membrane crossover of smaller redox species and increase cell capacity. FIG. 7. shows the structures of some illustrative redox active amphiphilic complexing agents.

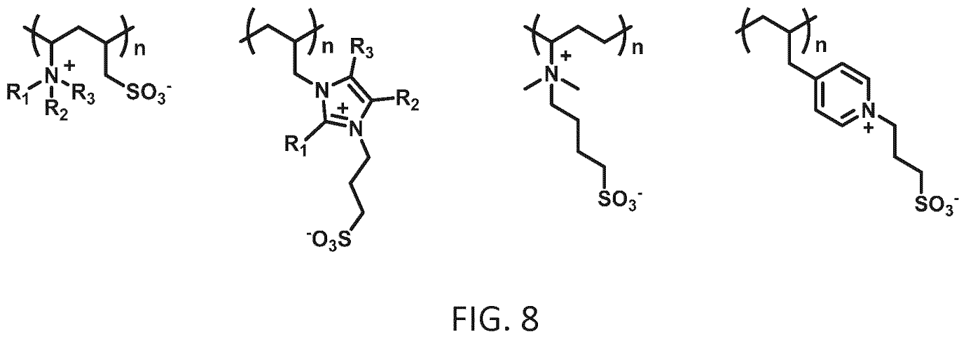

Polymeric amphiphilic complexing agents combine multiple soft ionic groups and multiple hard ionic groups along a polymer backbone chain. The soft ionic groups and hard ionic groups may be separate pendant groups along the polymer backbone or a polymer backbone may have multiple pendant groups, each pendant group comprising at least one soft ionic group and at least one hard ionic group. The structures of some illustrative polymeric amphiphilic complexing agents are illustrated in FIG. 8, where R₁-R₃ are, independently, hydrogen atoms, alkyl groups, alkyl alcohol groups, or polyether groups and n is an integer with a value of 1 or greater. By way of illustration, n may be in the range from 1 to 20, including in the range from 2 to 10. However, groups with n values outside of this range can be used.

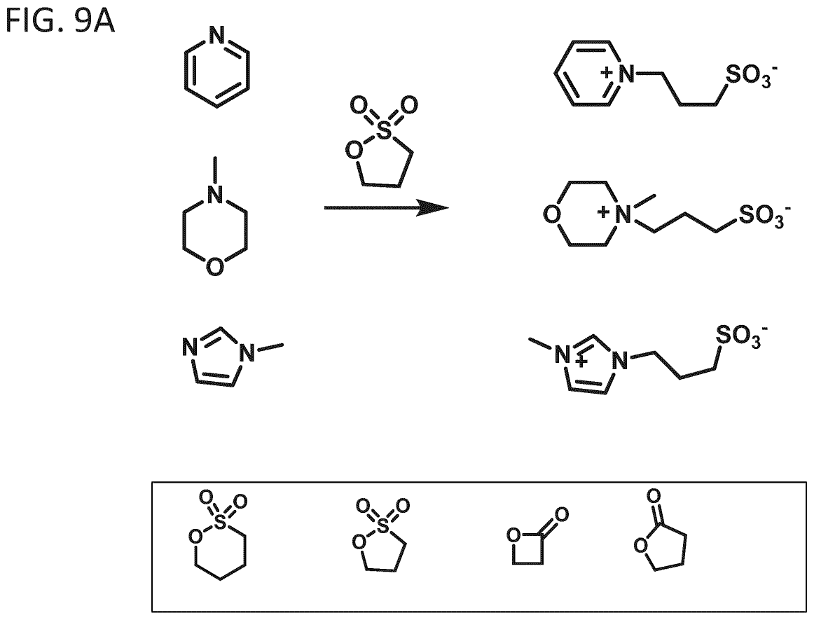

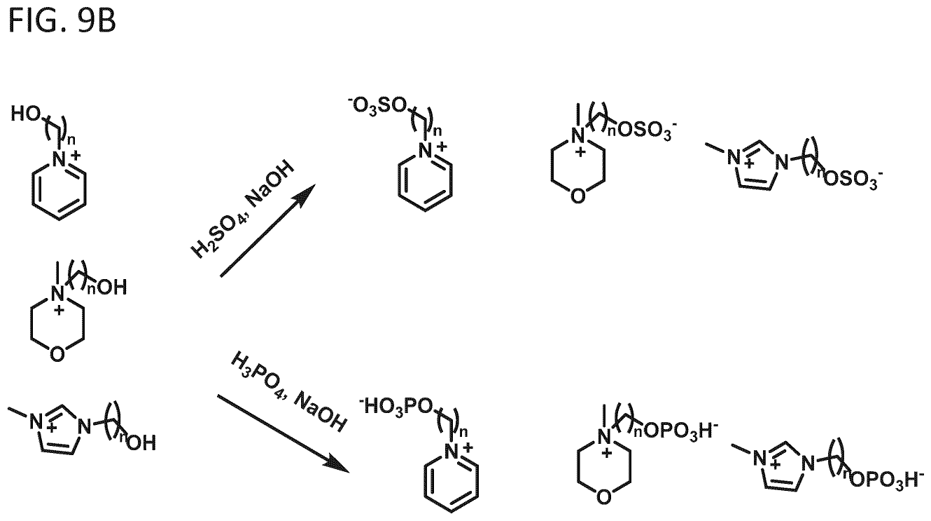

The amphiphilic complexing agents having a soft nitrogen-containing cation group and a hard anionic group can be made by reacting a cyclic or linear tertiary amine reactant, a reactant having a tertiary nitrogen-containing heterocyclic ring, or a reactant having a nitrogen-containing heteroaromatic ring with a cyclic sulfate, cyclic phosphate, and/or cyclic carboxylate to form an amphiphilic complexing agent comprising a positively charged nitrogen atom with a sulfonate, phosphonate, or carboxylate group on the nitrogen atom. A synthesis reaction of this type is shown in FIG. 9A. Various alternative cyclic anion-generating reactants that can be used in the reaction scheme are also shown in the figure (lower panel). Other synthesis schemes in which a cationic nitrogen-containing heteroaromatic or heterocyclic ring having a hydroxyl (—OH) substituent on the nitrogen atom is reacted with sulfuric or phosphoric acid to convert the hydroxyl group into a sulfate or phosphate group are shown in FIG. 9B.

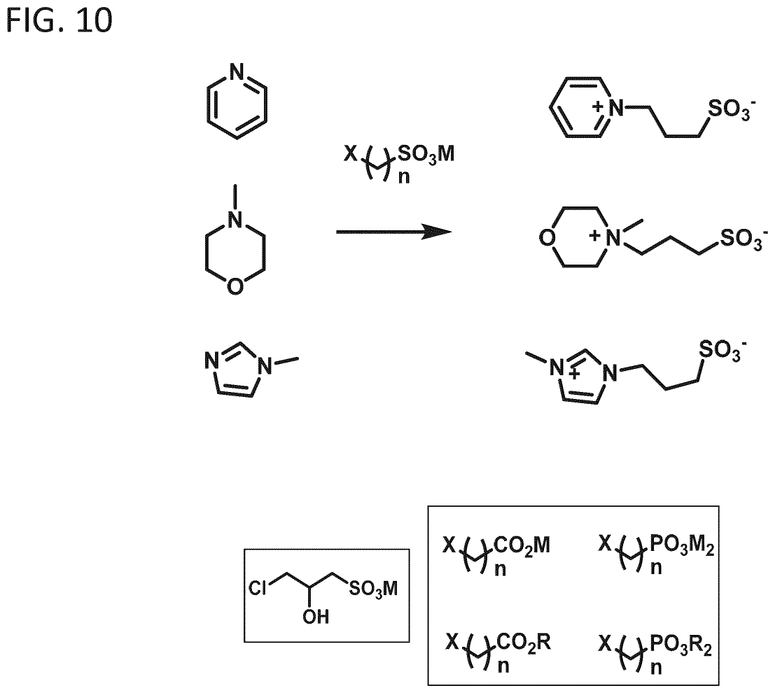

Alternatively, organic molecules having a hard anionic group, such as a —SO₃⁻, —PO₃²⁻, or —COO⁻ group, and a leaving group, such as a halogen atom, a mesylate (OM) group, or a tosylate (OT) group, can be reacted with the nitrogen atom of a tertiary amine via an S_{N}2 substitution to form an amphiphilic complexing agent comprising a positively charged nitrogen atom and a sulfonate, phosphonate, or carbonate group on the nitrogen atom. A synthesis reaction of this type is shown in FIG. 10. Examples of other organic molecules that can be used as reactants are shown in the bottom panels of the figure, where X represents a generic leaving group, M represents a generic charge-balancing cation, R represents an alkyl group, and n is an integer equal to or greater than 1.

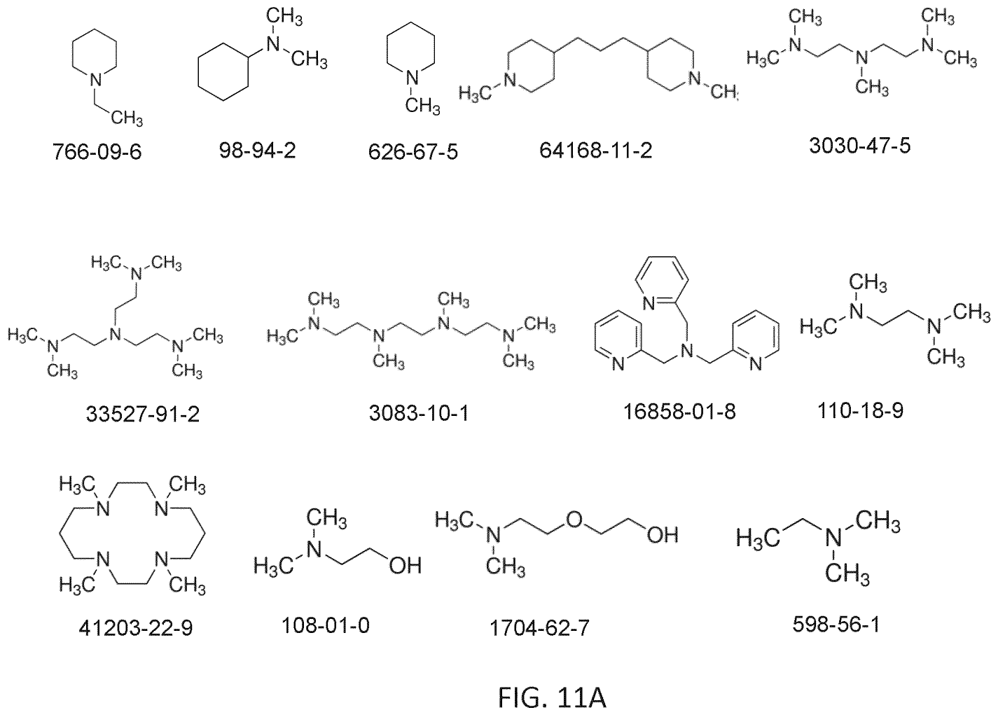

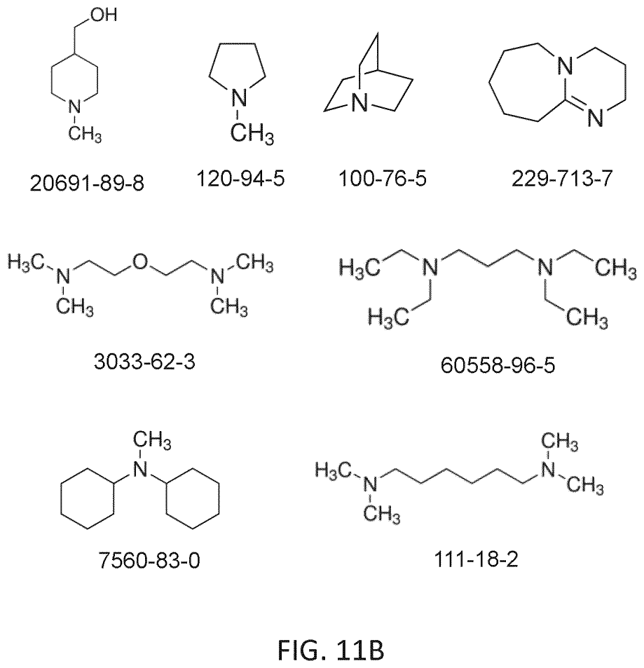

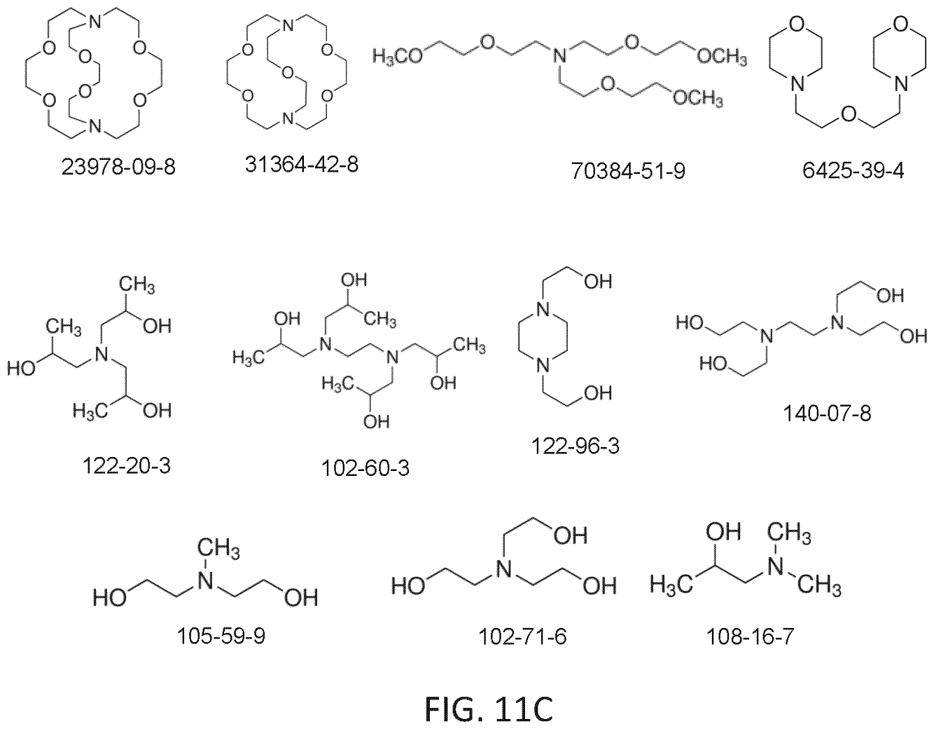

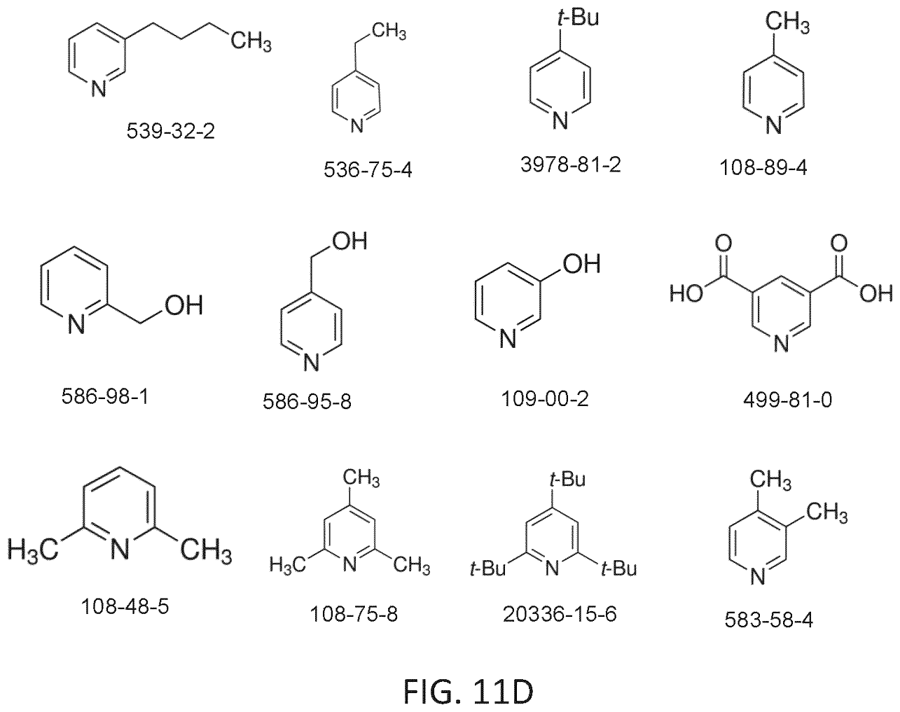

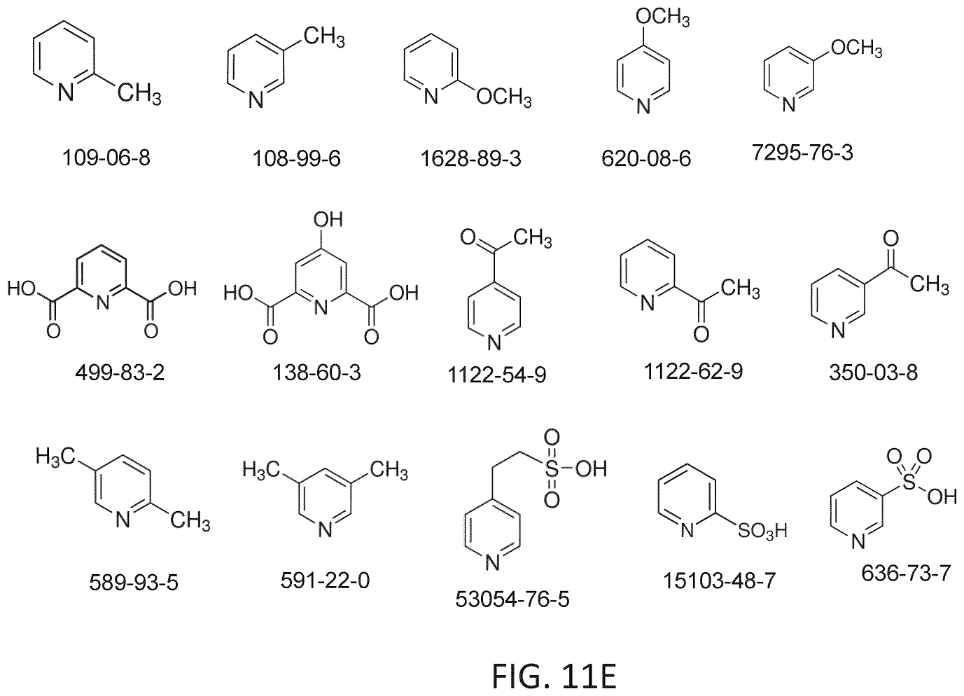

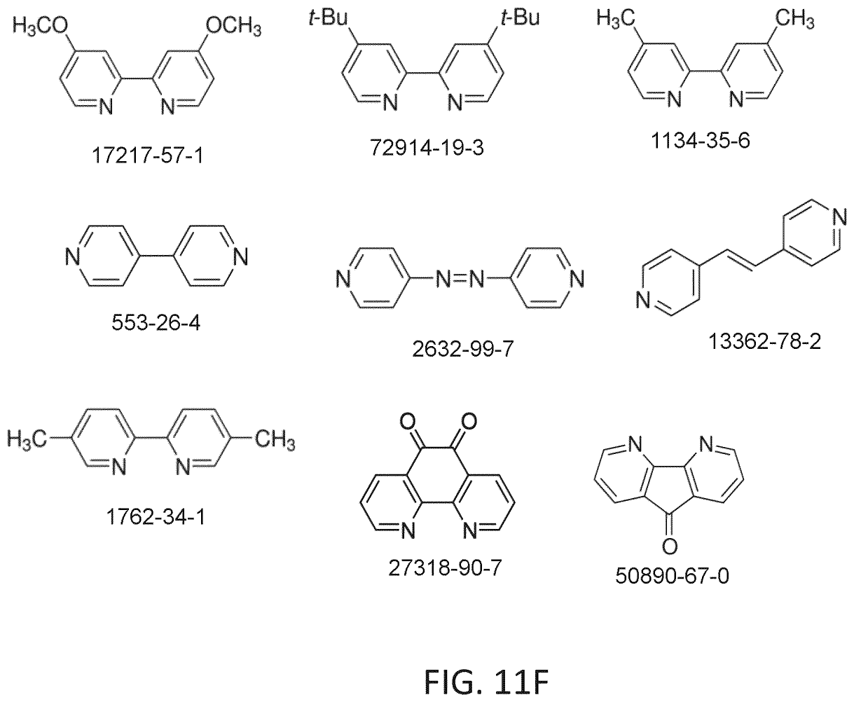

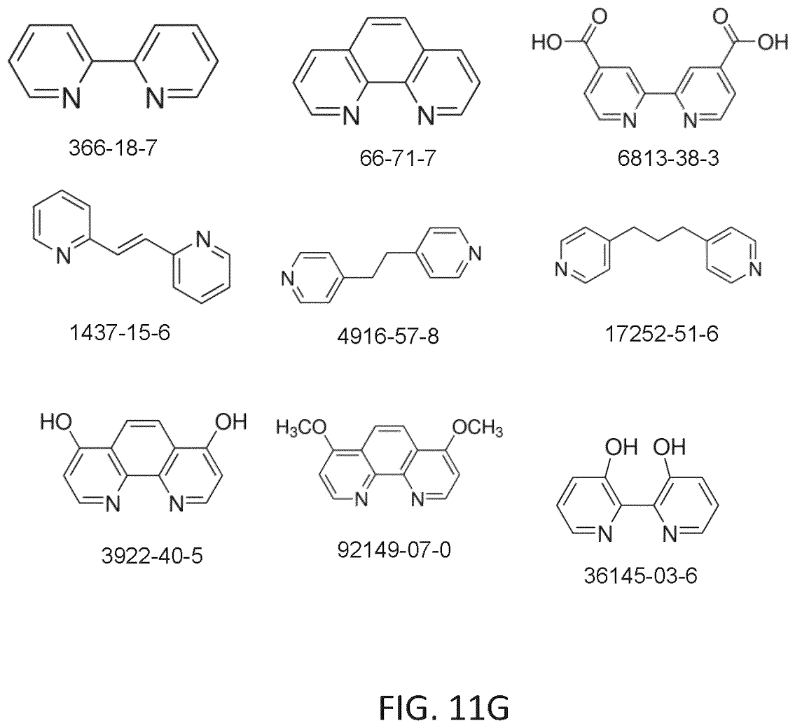

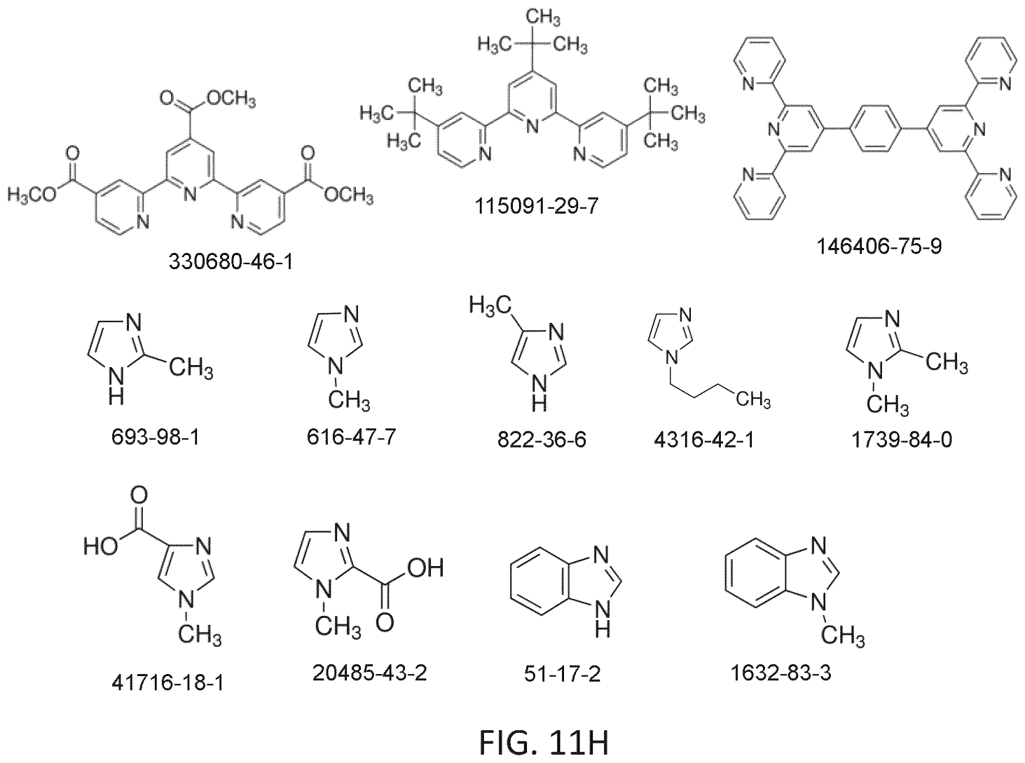

It should be noted that the tertiary amine and nitrogen-containing heterocyclic and heteroaromatic reactants shown in FIGS. 9A, 9B, and 10 are for illustrative purposes only. Many different tertiary amine, heterocyclic, and heteroaromatic reactants can be used, including many that are commercially available. For purposes of illustration, various commercially available reactants that can be used are shown in FIG. 11A-11H, along with their CAS numbers.

FIG. 11A shows the structures of 1-ethylpiperidine, N,N-dimethylcyclohexanamine, 1-methylpiperidine, 1-methyl-4-[3-(1-methylpiperidin-4-yl)propyl]piperidine, N′-[2-(dimethylamino)ethyl]-N,N,N′-trimethylethane-1,2-diamine, N′,N′-bis[2-(dimethylamino)ethyl]-N,N-dimethylethane-1,2-diamine, N′-[2-[2-(dimethylamino)ethyl-methylamino]ethyl], N,N,N′-trimethylethane-1,2-diamine, 1-pyridin-2-yl-N,N-bis(pyridin-2-ylmethyl)methanamine, N,N,N′,N′-tetramethylethane-1,2-diamine, 1,4,8,11-tetramethyl-1,4,8,11-tetrazacyclotetradecane, 2-(dimethylamino)ethanol, 2-[2-(dimethylamino)ethoxy]ethanol, and N,N-dimethylethanamine.

FIG. 11B shows the structures of (1-methylpiperidin-4-yl)methanol, 1-methylpyrrolidine, 1-azabicyclo[2.2.2]octane, 2,3,4,6,7,8,9,10-octahydropyrimido[1,2-a]azepine, 2-[2-(dimethylamino)ethoxy]-N,N-dimethylethanamine, N,N,N′,N′-tetraethylpropane-1,3-diamine, N-cyclohexyl-N-methylcyclohexanamine, and N,N,N′,N′-tetramethylhexane-1,6-diamine.

FIG. 1C shows the structures of 4,7,13,16,21,24-hexaoxa-1,10-diazabicyclo[8.8.8]hexacosane, 4,7,13,16,21-pentaoxa-1,10-diazabicyclo[8.8.5]tricosane, 2-(2-methoxyethoxy)-N,N-bis[2-(2-methoxyethoxy)ethyl]ethanamine, 4-[2-(2-morpholin-4-ylethoxy)ethyl]morpholine, 1-[bis(2-hydroxypropyl)amino]propan-2-ol, 1-[2-[bis(2-hydroxypropyl)amino]ethyl-(2-hydroxypropyl)amino]propan-2-ol, 2-[4-(2-hydroxyethyl)piperazin-1-yl]ethanol, 2-[2-[bis(2-hydroxyethyl)amino]ethyl-(2-hydroxyethyl)amino]ethanol, 2-[2-hydroxyethyl(methyl)amino]ethanol, 2-[bis(2-hydroxyethyl)amino]ethanol, and 1-(dimethylamino)propan-2-ol.

FIG. 11D shows the structures of 3-butylpyridine, 4-ethylpyridine, 4-tert-butylpyridine, 4-methylpyridine, pyridin-2-ylmethanol, pyridin-4-ylmethanol, pyridin-3-ol, pyridine-3,5-dicarboxylic acid, 2,6-dimethylpyridine, 2,4,6-trimethylpyridine, 2,4,6-tritert-butylpyridine, and 3,4-dimethylpyridine.

FIG. 11E shows the structures of 2-methylpyridine, 3-methylpyridine, 2-methoxypyridine, 4-methoxypyridine, 3-methoxypyridine, pyridine-2,6-dicarboxylic acid, 4-oxo-1H-pyridine-2,6-dicarboxylic acid, 1-pyridin-4-ylethanone, 1-pyridin-2-ylethanone, 1-pyridin-3-ylethanone, 2,5-dimethylpyridine, 3,5-dimethylpyridine, 2-(4-pyridyl)ethanesulfonic acid, pyridine-2-sulfonic acid, and 3-pyridinesulfonic acid

FIG. 11F shows the structures of 4-methoxy-2-(4-methoxypyridin-2-yl)pyridine, 4-tert-butyl-2-(4-tert-butylpyridin-2-yl)pyridine, 4-methyl-2-(4-methylpyridin-2-yl)pyridine, 4-pyridin-4-ylpyridine, dipyridin-4-yldiazene, 4-[(E)-2-pyridin-4-ylethenyl]pyridine, 5-methyl-2-(5-methylpyridin-2-yl)pyridine, 1,10-phenanthroline-5,6-dione, and 3,13 diazatricyclo[7.4.0.02,7]trideca-1(9),2(7),3,5,10,12-hexaen-8-one.

FIG. 11G shows the structures of 2-pyridin-2-ylpyridine, 1,10-phenanthroline, 2-(4-carboxypyridin-2-yl)pyridine-4-carboxylic acid, 2-[(E)-2-pyridin-2-ylethenyl]pyridine, 4-(2-pyridin-4-ylethyl)pyridine, 4-(3-pyridin-4-ylpropyl)pyridine, 1,10-dihydro-1,10-phenanthroline-4,7-dione, 4,7-dimethoxy-1,10-phenanthroline, and 2-(3-hydroxypyridin-2-yl)pyridin-3-ol.

FIG. 11H shows the structures of methyl 2,6-bis(4-methoxycarbonylpyridin-2-yl)pyridine-4-carboxylate, 4-tert-butyl-2,6-bis(4-tert-butylpyridin-2-yl)pyridine, 4-[4-(2,6-dipyridin-2-ylpyridin-4-yl)phenyl]-2,6-dipyridin-2-ylpyridine, 2-methylimidazole, 1-methylimidazole, 4-methylimidazole, 1-butylimidazole, 1,2-dimethylimidazole, 1-methylimidazole-4-carboxylic acid, 1-methylimidazole-2-carboxylic acid, and benzimidazole, 1-methylbenzimidazole.

As used herein, the term redox species refers generally to chemical species that undergo a transfer of electrons during the operation of an electrochemical cell. A variety of soft anionic or cationic redox species can be used in combination with the amphiphilic complexing agents. Soft anionic redox species include, but are not limited to, polyhalides, polysulfides, and thiolates. Polyhalide catholytes can be represented by the structure [Xₚ]⁻, where X represents a halogen atom, such as Br, I, or Cl, p is an integer with a value of from 3 to 29, and the X atoms that make up the polyhalide can be the same or different. Some polyhalide catholytes have the structure [X₁X₂X₃]⁻, where X₁, X₂, and X₃ are independently selected from halogen atoms, such as Br, I, and Cl. Specific examples of soft anionic trihalide catholytes include Br₃⁻, I₃⁻, Cl₃⁻, Br₂I⁻, I₂Br⁻, Br₂Cl⁻, BrCl₂⁻, I₂Cl⁻, ICl₂⁻, and BrICl⁻. Soft polysulfide anolytes have the structure [Sp]²⁻, where p is an integer with a value in the range from 1 to 4. The polyhalides and polysulfides may be associated with charge-balancing cations, such as H⁺ or metal cations (e.g., Li⁺, Na⁺, K⁺) or NH₄⁺. The amphiphilic complexing agents are particularly useful when combined with anionic catholytes, such as polyhalides, that are susceptible to being converted to gaseous or reactive species because the complexing of the polyhalides with the amphiphilic complexing agents can prevent such conversions. The anionic redox species can also be anionic metal-organic complexes, such as anionic metal-complexes having cyano, carboxylate, polycarboxylate, or poly aminocarboxylate ligands.

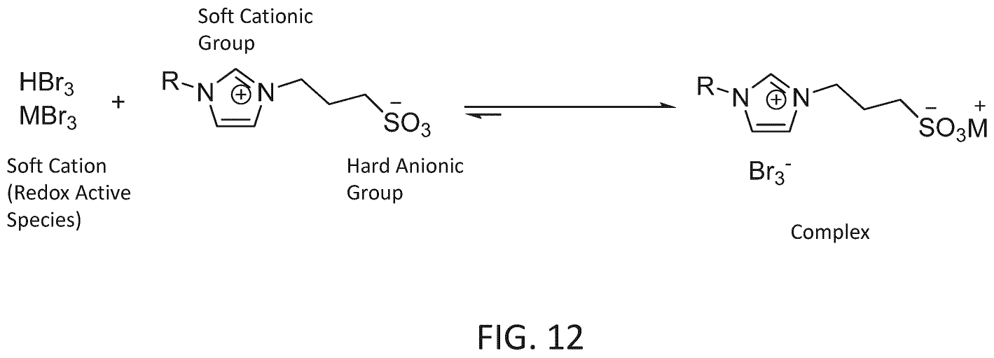

The complexing of an anionic redox species and an amphiphilic complexing agent having a soft cationic group and a hard anionic group in a catholyte solution is illustrated in FIG. 12. As shown in the figure, when a redox species in a soft anionic state, such as a polyhalide, is combined in solution with an amphiphilic complexing agent having a soft cationic group and a hard anionic group and/or a polyether chain, the soft anionic redox species couples to the soft cationic group of the complexing agent to form a complex of increased size that is soluble in the solution (right panel). Although a polyhalide catholyte (e.g., Br₃⁻) is used as the catholyte and a bifunctional molecule comprising an imidazolium group (soft cationic group) and a sulfonate group (hard anionic group) is used as the amphiphilic complexing agent in FIG. 12, other anionic redox species and/or amphiphilic complexing agents, including those described herein, can be used in the complexation scheme.

The amphiphilic complexing agents have applications in a variety of different devices in which an electrolyte solution is in contact with an ion-permeable membrane. Such applications include electrochemical and non-electrochemical ion separation devices. The basic components of an electrochemical device include an anode, an anolyte solution in contact with the anode, a cathode, a catholyte solution in contact with the cathode, an ion-permeable membrane separating the anolyte solution and the catholyte solution and an external wire or circuit connecting the anode to the cathode. At least one of the electrolyte solutions includes one or more redox species having a soft anionic state and one or more amphiphilic complexing agents, of a type described herein. When the redox species are in a soft anionic state they couple with the soft cationic group of the amphiphilic complexing agents via electrostatic equilibria, thereby reducing redox species crossover through the ion-permeable membrane. The anolyte solutions and catholyte solutions may be aqueous or non-aqueous. However, the amphiphilic complexing agents are particularly beneficial for use in aqueous electrolyte solutions because the hard anionic groups can render the complexes water-soluble. Electrochemical cells that incorporate the amphiphilic complexing agents described herein are characterized by long lifetimes with little capacity decay and high energy efficiencies.

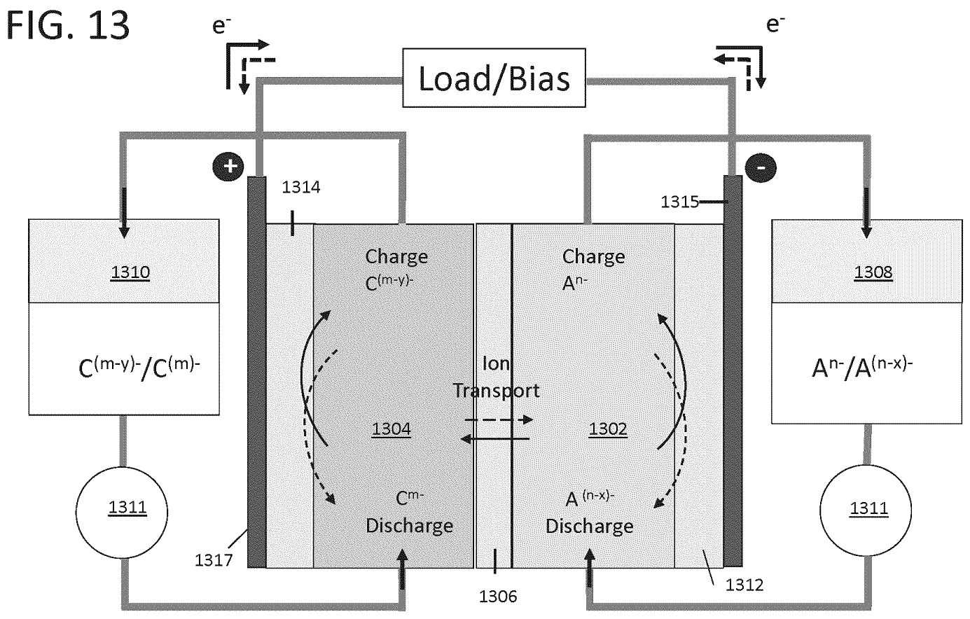

Aqueous organic redox flow batteries (AORFBs) are examples of electrochemical cells in which the amphiphilic complexing agents can be used. One embodiment of an AORFB that includes an ion-selective membrane is shown schematically in FIG. 13. In the AORFBs, redox-active chemical species are dissolved in an aqueous supporting electrolyte solution where they serve as anode and cathode electrolytes. These anode and cathode electrolytes, which are referred to as anolytes and catholytes, respectively, may be contained in an anode cell compartment 1302 and a cathode cell compartment 1304. For simplicity, in FIG. 13 the anolytes are represented generically as “A”, the catholytes are represented generically as “C”, the charge on the anolyte in its oxidized and reduced states is represented by n- and (n-x)-, respectively, and the charge on the catholyte in its oxidized and reduced states is represented by m- and (m-y)-, respectively. An ion-conducting membrane 1306 separates anode cell compartment 1302 from cathode cell compartment 1304.

During the charge-discharge process, the redox-active anolyte and catholyte are stored in an anolyte reservoir 1308 and a catholyte reservoir 1310, respectively. Reservoirs 1308 and 1310 are in fluid communication with their respective cell compartments 1302 and 1304, such that the anolyte and catholyte can be circulated through the cell compartments. This circulation can be accomplished using, for example, a pump 1311. During the charging process, a bias is applied across an anode 1312 in anode cell compartment 1302 and a cathode 1314 in cathode cell compartment 1304. As shown in FIG. 13, an anode current collector 1315 and a cathode current collector 1317 can be used to provide electrical conduction between the electrodes and an external circuit. During the charging process, as the anolyte passes over anode 1312, the anolyte molecules undergo electrochemical reduction reactions, while the catholyte molecules passing over cathode 1314 undergo electrochemical oxidation reactions. During the discharge process, the anolyte molecules undergo electrochemical oxidation reactions, while the catholyte molecules passing over cathode 1314 undergo electrochemical reduction reactions to power a load that is connected across anode 1312 and cathode 1314.

Ion-permeable membranes that can be used with the electrolyte solutions described herein include, but are not limited to, membranes bearing positive charges (“cationic membranes”) because electrostatic repulsion between the hard anionic group of the amphiphilic complexing agents and the positively charged membrane further reduces unwanted membrane crossover.

A variety of redox species can be used as counter anolytes or catholytes, including both inorganic (e.g., sulfide/polysulfide, Zn/ZnX₂ (X=I, Br, Cl), Cr²⁺/Cr³⁺, ferro/ferricyanide) and organic redox couples (e.g., viologens, anthraquionones, phenazines, thiolate) Viologen derivatives, such as bis(3-trimethylammonio)propyl viologen tetrachloride, and other pyridyl derivatives, such as those described in U.S. patent application Ser. No. 17/734,377 and in Lv, Xiu-Liang, et al ACS Energy Letters 7 (2022): 2428-2434, are examples of anolytes that can be used in the electrochemical cells, including AORFBs. However, other anolytes can be used.

In the electrolyte solution, the non-redox active amphiphilic complexing agents can act as supporting electrolytes. As used herein, the term “non-redox active” refers to amphiphilic complexing agents that do not undergo a reversible redox reaction when the electrochemical cell is in operation. Optionally, one or more additional supporting electrolytes can be included. Supporting electrolytes are chemical species (e.g., salts) that are not electroactive in the electrochemical cell's range of applied potentials, but have high ionic strengths and, therefore, contribute to the conductivity of the solution.

### EXAMPLE

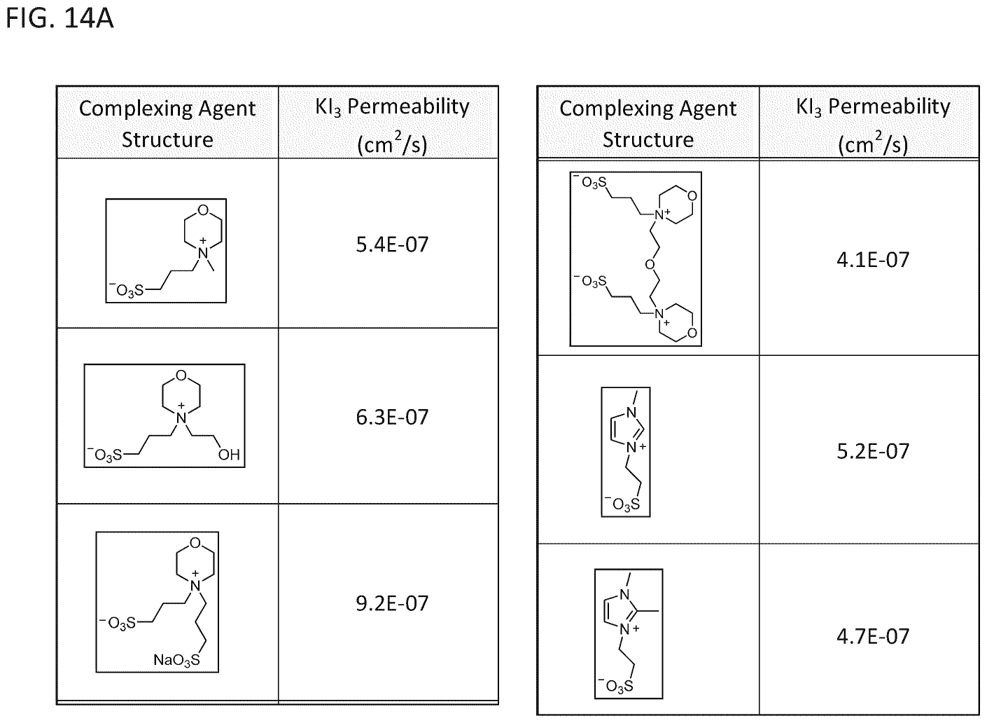

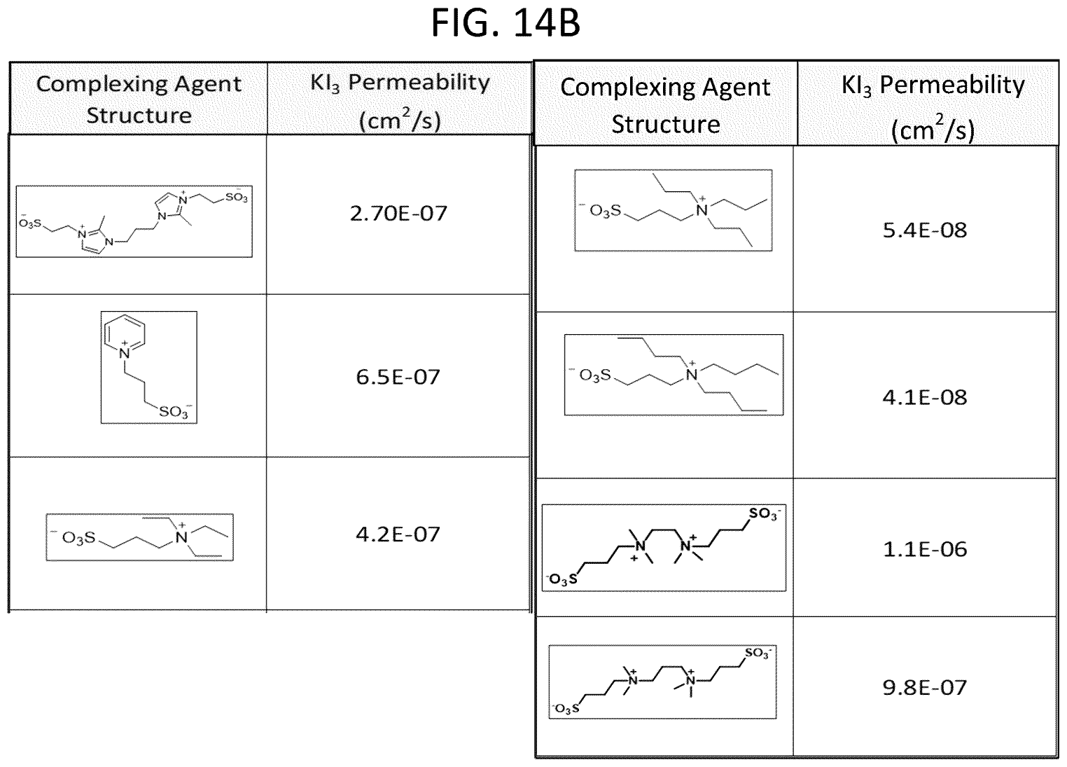

This example describes the synthesis, ion permeabilities, and battery cycling of the 13 amphiphilic complexing agents shown in FIGS. 14A and 14B.

Synthesis.

For the eight monomeric amphiphilic complexing agents of FIG. 14A: 0.5 mol of 4-methylmorpholine, 2-morpholinoethan-1-ol, 1-methyl-1H-imidazole, 1,2-dimethyl-1H-imidazole, pyridine, triethylamine, tripropylamine or tributylamine and 0.5 mol 1,3-propane sultone were dissolved in 200 mL acetone and placed in a 500 mL round bottom flask. The resulting mixture was stirred at 50° C. for 48 h. After cooling to room temperature, the products were obtained by filtration, washed with acetone (100 mL*3) and dried in oven at 50° C. overnight. The yield was 92 to 98%.

For the five dimer amphiphilic complexing agents of FIG. 14B: 0.2 mol of N1,N1,N2,N2-tetramethylethane-1,2-diamine, N1,N1,N3,N3-tetramethylpropane-1,3-diamine, 1,3-bis(2-methyl-1H-imidazol-1-yl)propane, dimorpholinodiethyl ether or MOPS-Na and 0.5 mol 1,3-propane sultone were dissolved in 200 mL methanol and placed in a 500 mL round bottom flask. The resulting mixture was refluxed at 75° C. for 72 h. After cooling to room temperature, the solvent was evaporated by rotary evaporator. The solid products were washed with acetone (100 mL*3) and dried in oven at 50° C. overnight. The yield was 92%.

Ion-Permeability:

The tables in FIGS. 14A and 14B list the permeability of potassium triiodide through a CMVN cation-exchange membrane in the presence of the representative amphiphilic complexing agents of FIGS. 14A and 14B. Measurements were performed using a standard H-cell setup, and concentration of the receiving side was monitored using UV-Vis. All complexing reagents exhibited orders of magnitude potassium triiodide crossover reduction, as the permeability of potassium triiodide through the CMVN membrane without a complexing reagent was on the order of magnitude of 10⁻⁵ cm²/s.

Battery Cycling:

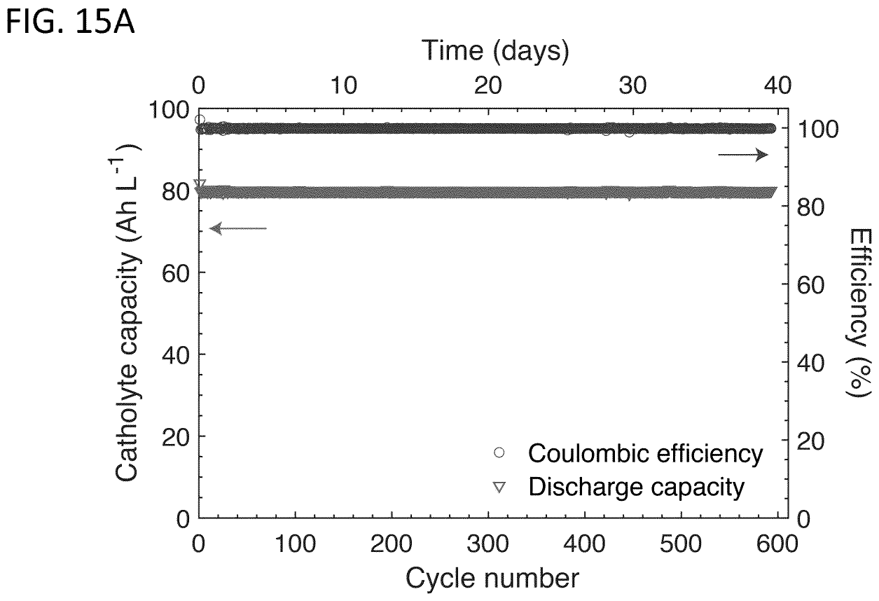

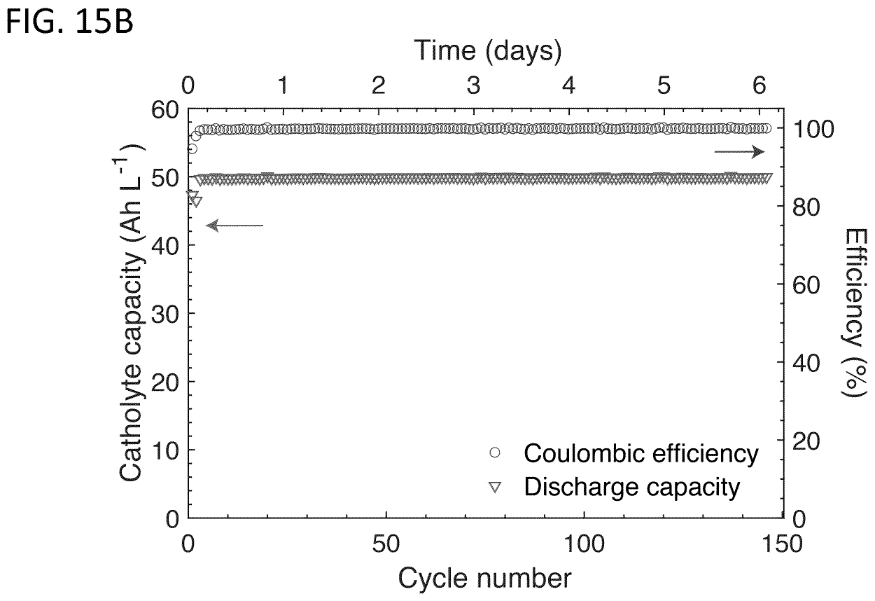

The amphiphilic complexing agent concept was demonstrated in a redox flow battery with an anionic halide catholyte. FIG. 15A shows the results for continuous cycling of 10 mL 4.5M KI with 4.5M of a 3-(triethylammonium)-propylsulfonate catholyte with excess (45 mL) of 1M bis(propylsulfonate) viologen with 4.5M KI anolyte. FIG. 15B shows the results for continuous cycling of 10 mL 3M KBr with 3M of 3-(triethylammonium)-propylsulfonate catholyte with excess (30 mL) of 1M bis(propylsulfonate) viologen with 3M KBr anolyte. Both experiments charged the halide fully to the trihalide state (⅔ of full capacity), exhibited no capacity decay with nearly 100% coulombic efficiency, and remained homogenous during cycling with minimal observed vapors.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” can mean only one or can mean “one or more.” Embodiments of the inventions consistent with either construction are covered.

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

If not already included, all numeric values of parameters in the present disclosure are proceeded by the term “about” which means approximately. This encompasses those variations inherent to the measurement of the relevant parameter as understood by those of ordinary skill in the art. This also encompasses the exact value of the disclosed numeric value and values that round to the disclosed numeric value.

What is claimed is:

1. A redox flow cell comprising:
an anode cell compartment comprising an anode in an anolyte solution;
an anolyte reservoir in fluid communication with the anode cell compartment;
a cathode cell compartment comprising a cathode in a catholyte solution;
a catholyte reservoir in fluid communication with the cathode cell compartment; and
an ion-permeable membrane separating the anolyte solution from the catholyte solution, wherein one or both of the anolyte solution and the catholyte solution comprises:
a solvent;
an ionic redox species dissolved in the solvent;
charge-balancing counter ions dissolved in the solvent; and
an amphiphilic complexing agent dissolved in the solvent, wherein the amphiphilic complexing agent comprises an anionic group linked to a cation group by an organic linker chain.

2. The redox flow cell of claim 1, wherein the anionic group is a sulfate group, a phosphate group, or a carboxylate group.

3. The redox flow cell of claim 1, wherein the cationic group is a cationic aliphatic quaternary ammonium group, protonated secondary or tertiary ammonium group, cyclic quaternary ammonium group, or nitrogen-containing heteroaromatic ring.

4. The redox flow cell of claim 3, wherein the cationic group comprises an alkyl substituent, an alkyl alcohol substituent, a polyether substituent, or a combination of two or more thereof.

5. The redox flow cell of claim 3, wherein the cationic group is an imidazolium group, a benzimidazolium group, a pyridinium group, a bipryridinium group, a 1,4-diazabicyclo[2.2.2]octane-1,4-diium group, an aziridinium group, an azetidinium group, a pyrrolidinium group, a piperidinium group, a morpholinium group, a piperazinium group, or an imidazolidinium group.

6. The redox flow cell of claim 1, wherein the cationic group is a sulfonium cation or a phosphonium cation.

7. The redox flow cell of claim 1, wherein the amphiphilic complexing agent comprises at least two of the anionic groups.

8. The redox flow cell of claim 1, wherein the amphiphilic complexing agent comprises at least two of the cationic groups.

9. The redox flow cell of claim 1, wherein the amphiphilic complexing agent is a polymeric amphiphilic complexing agent comprising a plurality of the anionic groups and a plurality of the cationic groups along a polymer backbone chain.

10. The redox flow cell of claim 1, wherein the amphiphilic complexing agent is non-redox active.

11. The redox flow cell of claim 1, where the ionic redox species is an anionic redox species and the charge-balancing counter ions are cations.

12. The redox flow cell of claim 11, wherein the ionic redox species comprises a polyhalide, a polysulfide, or a thiolate.

13. The redox flow cell of claim 12, wherein the charge-balancing counter ions comprise H⁺, metal cations, or NH₄⁺.

14. The redox flow cell of claim 1, where the ionic redox species is a cationic redox species and the charge-balancing counter ions are anions.

15. The redox flow cell of claim 14, wherein the ionic redox species comprises a cationic metal-organic complex.

16. The redox flow cell of claim 15, wherein the charge-balancing counter ions comprise halide ions, sulfate ions, hydroxide ions, nitrate ions, phosphate ions, borate ions, and chlorate ions.

17. The redox flow cell of claim 1, wherein the solvent comprises water.

18. The redox flow cell of claim 1, wherein the ion-permeable membrane is an ion-exchange or size-exclusion membrane.

19. An electrolyte solution comprising:
a solvent;
an ionic redox species dissolved in the solvent;
charge-balancing counter ions dissolved in the solvent; and
an amphiphilic complexing agent dissolved in the solvent, wherein the amphiphilic complexing agent comprises an anionic group linked to a cation group by an organic linker chain.

20. The electrolyte solution of claim 19, wherein the anionic group is a sulfate group, a phosphate group, or a carboxylate group, and the cationic group is an aliphatic quaternary ammonium group, protonated secondary or tertiary ammonium group, a cyclic quaternary ammonium group, a nitrogen-containing heteroaromatic ring, of a sulfonium cation or a phosphonium cation.
